(19) United States
(12) Patent Application Publication
(10) Pub. No.: US 2025/0187394 A1
(43) Pub. Date: Jun. 12, 2025

(54) INFORMATION PROCESSING DEVICE AND STORAGE MEDIUM

(71) Applicant: TOYOTA JIDOSHA KABUSHIKI KAISHA, Toyota-shi (JP)

(72) Inventor: Tatsuyoshi OMURA, Tokyo (JP)

(73) Assignee: TOYOTA JIDOSHA KABUSHIKI KAISHA, Toyota-shi (JP)

(21) Appl. No.: 18/952,688

(22) Filed: Nov. 19, 2024

(30) Foreign Application Priority Data
Dec. 11, 2023 (JP) 2023-208839

(51) Int. Cl. B60H 1/00; B60R 16/033

(52) U.S. Cl. CPC B60H 1/0073; B60R 16/033

(57) ABSTRACT

An information processing device that executes remote control on a vehicle that executes a first mode in which an air conditioner is operated without operating an internal combustion engine, and a second mode in which the air conditioner is operated by operating the internal combustion engine. The information processing device include one or more processors. The one or more processors are configured to acquire a user-specified mode that is the first mode or the second mode and is specified by a user of the vehicle, and transmit an execution request for the user-specified mode to an external device related to the vehicle in response to acquiring of the user-specified mode.

### CROSS-REFERENCE TO RELATED APPLICATION

This application claims priority to Japanese Patent Application No. 2023-208839 filed on Dec. 11, 2023, incorporated herein by reference in its entirety.

### BACKGROUND

### 1. Technical Field

The present disclosure relates to an information processing device and a non-transitory storage medium.

### 2. Description of Related Art

There is known a technology in which, in a system that operates an electric air conditioner mounted on a hybrid electric vehicle (HEV) or a plug-in hybrid electric vehicle (PHEV) before a user gets into the vehicle, an internal combustion engine is operated to charge a battery and the air conditioner is operated when the remaining battery charge level is equal to or less than a predetermined level (see, for example, Japanese Unexamined Patent Application Publication No. 2012-188062 (JP 2012-188062 A)).

### SUMMARY

An object of the present disclosure is to provide a technology that can improve the convenience for a user who uses remote air conditioning.

One aspect of the present disclosure relates to an information processing device for remote control on a vehicle that executes a first mode in which an air conditioner is operated without operating an internal combustion engine, and a second mode in which the air conditioner is operated by operating the internal combustion engine.
The information processing device includes one or more processors.
The processor is configured to: acquire a user-specified mode that is the first mode or the second mode and is specified by a user of the vehicle; and transmit an execution request for the user-specified mode to an external device related to the vehicle in response to acquiring of the user-specified mode.

Another aspect of the present disclosure relates to a non-transitory storage medium storing instructions that are executable by a computer for remote control on a vehicle and that cause the computer to perform functions, the vehicle executing a first mode in which an air conditioner is operated without operating an internal combustion engine, and a second mode in which the air conditioner is operated by operating the internal combustion engine.

In that case, the program causes, for example, the computer to: acquire a user-specified mode that is the first mode or the second mode and is specified by a user of the vehicle; and transmit an execution request for the user-specified mode to an external device related to the vehicle in response to acquiring of the user-specified mode.

Other aspects of the present disclosure may relate to a method in which a computer executes the processes of the above information processing device, and program in a computer-readable form.

According to the present disclosure, it is possible to provide the technology that can improve the convenience for the user who uses the remote air conditioning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a diagram schematically showing an example of an execution request according to the embodiment;

FIG. 3 is a diagram schematically showing an example of an operation command according to the embodiment;

FIG. 4 is a diagram schematically showing an example of the hardware configurations of a vehicle, a user terminal, and a server in the system according to the embodiment;

FIG. 5 is a diagram schematically showing an example of mode data according to the embodiment;

FIG. 6 is a block diagram schematically showing an example of the software configuration of the user terminal according to the embodiment;

FIG. 7 is a diagram showing an example of a remote air conditioning menu screen according to the embodiment;

FIG. 8 is a diagram showing an example of a user-specified mode setting screen according to the embodiment;

FIG. 9 is a diagram showing an example of an execution condition setting screen associated with a first mode according to the embodiment;

FIG. 10 is a diagram showing an example of an execution condition setting screen associated with a second mode according to the embodiment;

FIG. 11 is a diagram showing an example of an operation reception screen according to the embodiment;

FIG. 12 is a flowchart showing an example of a processing routine to be executed by the user terminal when a user-specified mode and an execution condition are set according to the embodiment;

FIG. 13 is a flowchart showing an example of a processing routine to be executed by the user terminal when an operation for remote air conditioning is received according to the embodiment;

FIG. 14 is a block diagram schematically showing an example of the software configuration of a user terminal according to a first modification;

FIG. 15 is a diagram showing an example of a remote air conditioning menu screen according to the first modification;

FIG. 16 is a diagram showing an example of a user-specified mode setting screen according to the first modification;

FIG. 17 is a diagram schematically showing an example of vehicle information;

FIG. 18 is a flowchart showing a processing flow to be executed in place of a process of step S201 in FIG. 13 according to the first modification;

FIG. 19 is a block diagram schematically showing an example of the software configuration of a user terminal according to a second modification;

FIG. 20 is a diagram showing an example of an actual record notification screen according to the second modification; and

FIG. 21 is a flowchart showing an example of a processing routine to be executed by the user terminal when an operation for remote air conditioning is received according to the second modification.

### DETAILED DESCRIPTION OF EMBODIMENTS

In recent years, remote air conditioning in which a user operates an air conditioner of a parked vehicle by remote control via a user terminal such as a smartphone has been widespread. For example, the following technology is known in an HEV or a PHEV including an electric air conditioner. When a request to operate the air conditioner is given by remote control and the remaining battery charge level is equal to or greater than a threshold, the air conditioner is operated using battery power without operating an internal combustion engine (first mode). When the request is given and the remaining battery charge level is less than the threshold, the internal combustion engine is operated to charge the battery and the air conditioner is operated using the battery power (second mode).

When the first mode or the second mode is selected automatically, the air conditioner may be operated in a mode that is not intended by the user and the convenience for the user may decrease. Therefore, there is a demand for measures to secure the convenience for the user who uses the remote air conditioning.

The present disclosure relates to an information processing device for remote control on a vehicle configured to execute a first mode in which an air conditioner is operated without operating an internal combustion engine, and a second mode in which the air conditioner is operated by operating the internal combustion engine. The information processing device according to the present disclosure may be a terminal such as a smartphone that is used by a user of the vehicle, or may be a dedicated terminal. In one example, the vehicle that undergoes remote control may be an HEV or a PHEV including an electric air conditioner. In this case, the first mode may be a mode in which the air conditioner is operated using battery power without operating the internal combustion engine, and the second mode may be a mode in which the air conditioner is operated using battery power while operating the internal combustion engine to generate electric power (charge the battery). In another example, the vehicle that undergoes remote control may be an HEV or a PHEV including an electric air conditioner to be driven by battery power and a mechanical air conditioner to be driven by power of an internal combustion engine. In this case, the first mode may be a mode in which the electric air conditioner is operated using battery power, and the second mode may be a mode in which the mechanical air conditioner is operated using power of the internal combustion engine.

In the information processing device according to the present disclosure, a control unit (processor) is configured to acquire a user-specified mode. The user-specified mode is the first mode or the second mode and is specified by the user of the vehicle. In one example, the user-specified mode may be specified in advance by the user of the vehicle and stored in a storage unit (memory) of the information processing device according to the present disclosure. In this case, the control unit of the information processing device according to the present disclosure may be configured to execute the following in advance: outputting a second screen for specifying the first mode or the second mode; receiving an operation to specify the first mode or the second mode while the second screen is output; and storing the first mode or the second mode specified by the received manipulation in the storage unit as the user-specified mode. In this case, the control unit of the information processing device according to the present disclosure may be configured to acquire the user-specified mode by reading the user-specified mode stored in the storage unit.

The control unit of the information processing device according to the present disclosure transmits an execution request for the user-specified mode to an external device related to the vehicle in response to acquisition of the user-specified mode. In a configuration in which the execution request is directly transmitted from the information processing device to the vehicle, the external device related to the vehicle may be a device mounted on the vehicle. In a configuration in which the execution request is indirectly transmitted from the information processing device to the vehicle via a server, the external device related to the vehicle may be the server.

With the information processing device according to the present disclosure, it is possible to operate the air conditioner of the vehicle in the first mode or the second mode specified by the user (user-specified mode). Therefore, it is possible to suppress execution of the remote air conditioning in a mode that is not intended by the user. As a result, the convenience for the user who uses the remote air conditioning can be secured.

In the information processing device according to the present disclosure, the user may select whether to execute the remote air conditioning in the user-specified mode before the execution request is transmitted to the external device related to the vehicle. In one example, the control unit of the information processing device according to the present disclosure may, in response to the acquisition of the user-specified mode, output a first screen for selection as to whether to execute the acquired user-specified mode, receive an operation to select execution of the user-specified mode while the first screen is output, and transmit the execution request for the user-specified mode to the external device related to the vehicle in response to reception of the operation to select the execution of the user-specified mode.

The remaining battery charge level or the remaining fuel level may be less than that expected by the user due to the remote air conditioning executed in the user-specified mode. Therefore, when the user specifies the user-specified mode, the user may set an execution condition for the user-specified mode. In one example, the control unit of the information processing device according to the present disclosure may be configured to output a third screen for setting the execution condition for the user-specified mode, receive an operation to set the execution condition while the third screen is output, and store the execution condition set by the received manipulation in the storage unit in association with the user-specified mode. In this case, the control unit of the information processing device according to the present disclosure may be configured to, when transmitting the execution request for the user-specified mode to the external device, acquire the execution condition stored in the storage unit, and transmit the acquired execution condition to the external device together with the execution request for the user-specified mode. Therefore, the vehicle can execute the user-specified mode only when the received execution condition is satisfied. As a result, it is possible to avoid the situation in which the remaining battery charge level or the remaining fuel level is less than that expected by the user due to the execution of the user-specified mode.

The control unit of the information processing device according to the present disclosure may further be configured to acquire, after the user-specified mode is executed in the vehicle, an actual record value of a battery charge amount or a fuel amount consumed by execution of the user-specified mode, and output the acquired actual record value. Thus, the user of the vehicle can specify the user-specified mode and/or set the execution condition using, as an index, the actual record value of the battery charge amount or the fuel amount consumed by the execution of the user-specified mode. As a result, the user of the vehicle can specify the user-specified mode and/or set the execution condition more appropriately.

The user-specified mode may be specified by the user when transmitting the execution request for the user-specified mode to the external device. In this case, the acquiring of the user-specified mode may include outputting a fourth screen for specifying the first mode or the second mode, receiving an operation to specify the first mode or the second mode while the fourth screen is output, and acquiring the first mode or the second mode specified by the received manipulation as the user-specified mode. The current remaining battery charge level and the current remaining fuel level may be displayed on the fourth screen. Thus, the user of the vehicle can specify the user-specified mode by referring to the current remaining battery charge level and the current remaining fuel level.

In the configuration in which the user-specified mode is specified when transmitting the execution request for the user-specified mode to the external device, the control unit of the information processing device according to the present disclosure may further be configured to output a fifth screen for setting the execution condition for the user-specified mode, receive an operation to set the execution condition while the fifth screen is output, and transmit the execution condition set by the received manipulation to the external device together with the execution request.

Hereinafter, an embodiment of the present disclosure will be described with reference to the drawings. The configuration of the following embodiment is illustrative, and the present embodiment described below is merely an example of the present disclosure in all respects. Various revisions or modifications may be made without departing from the scope of the present disclosure. In the implementation of the present disclosure, specific configurations may be employed as appropriate depending on embodiments. Data that appears in the present embodiment will be described using natural language, but more specifically, it is specified using pseudo language, commands, parameters, machine language, etc. that can be recognized by a computer.

### EMBODIMENT

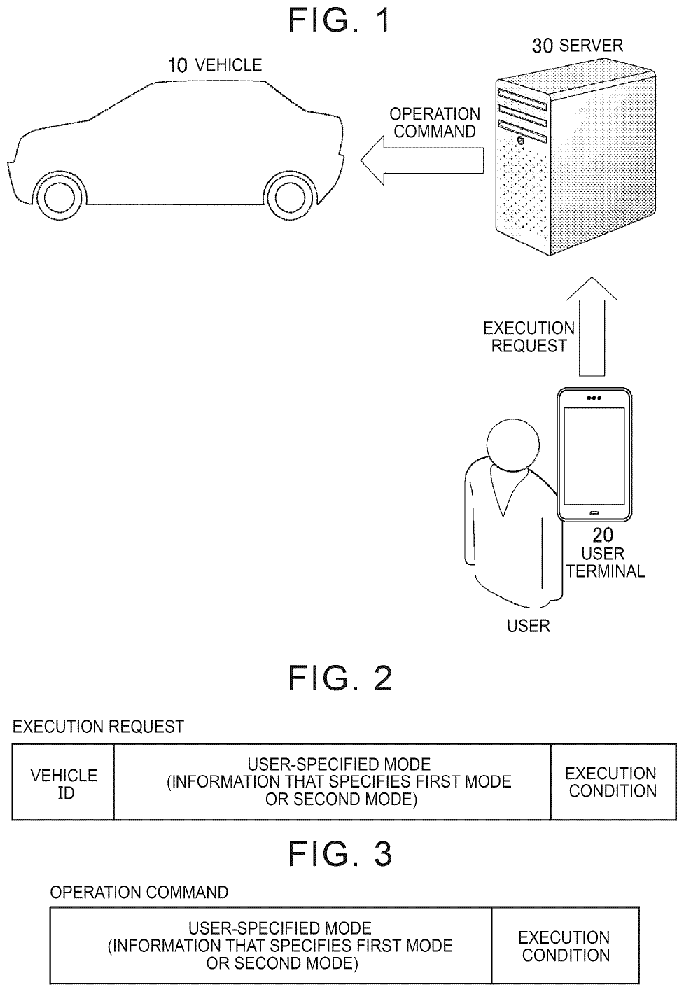

FIG. 1 is a diagram schematically showing an example of a system to which the present disclosure is applied. The system according to the present embodiment includes a vehicle 10, a user terminal 20, and a server 30, and provides a remote air conditioning service to a user of the vehicle 10. Although FIG. 1 shows one vehicle 10 and one user terminal 20, the system may include a plurality of vehicles 10 and a plurality of user terminals 20 under the management of the server 30.

The vehicle 10 is an HEV or a PHEV including an air conditioner 120, a battery 130, an electric motor 140, an internal combustion engine 150, a generator 160, etc. described later. The vehicle 10 in the present embodiment is configured to execute remote air conditioning in a first mode and remote air conditioning in a second mode. The remote air conditioning refers to remote control on the air conditioner 120 of the parked vehicle 10 (a power switch or an ignition switch is OFF) via the user terminal 20. The first mode is a mode in which the air conditioner 120 is operated using electric power of the battery 130 without operating the internal combustion engine 150. The second mode is a mode in which the internal combustion engine 150 is operated to generate electric power using the generator 160 (to charge the battery 130) and the air conditioner 120 is operated using the electric power of the battery 130.

The user terminal 20 is a computer that is used by the user of the vehicle 10, and a dedicated application program adapted to remote air conditioning is installed in the user terminal 20. The user terminal 20 has, through the execution of the dedicated application program, a function of presenting a remote air conditioning menu to the user, a function of presenting an operation screen associated with each item in the menu to the user, a function of executing a process associated with an operation selected by the user on the operation screen, etc. In the present embodiment, the user terminal 20 corresponds to an “information processing device” according to the present disclosure.

In one example, the remote air conditioning menu includes settings of the remote air conditioning and execution of the remote air conditioning. Manipulation screens associated with the settings of the remote air conditioning include an operation screen for setting a user-specified mode, an operation screen for setting an execution condition for the user-specified mode, etc. The user-specified mode is the first mode or the second mode, and is a mode specified by the user as desired. The execution condition is a condition to determine, in the vehicle 10, whether to execute the user-specified mode.

When the user-specified mode is the first mode, the execution condition may be, for example, a lower limit value (hereinafter sometimes referred to as “first threshold”) of the remaining battery charge level (state of charge (SOC)). When the remaining battery charge level of the vehicle 10 is equal to or greater than the first threshold, determination may be made that the execution condition for the first mode is satisfied. When the remaining battery charge level of the vehicle 10 is less than the first threshold, determination may be made that the execution condition for the first mode is not satisfied.

When the user-specified mode is the second mode, the execution condition may be, for example, a lower limit value (hereinafter sometimes referred to as “second threshold”) of the remaining fuel level. When the remaining fuel level of the vehicle 10 is equal to or greater than the second threshold, determination may be made that the execution condition for the second mode is satisfied. When the remaining fuel level of the vehicle 10 is less than the second threshold, determination may be made that the execution condition for the second mode is not satisfied.

Manipulation screens associated with the execution of the remote air conditioning include an operation screen for selecting whether to execute the user-specified mode, etc. When an operation to select the execution of the user-specified mode is performed on the operation screen associated with the execution of the remote air conditioning, the user terminal 20 transmits, to the server 30, a signal (execution request) for requesting the execution of the remote air conditioning in the user-specified mode. For example, the execution request may include, as shown in FIG. 2, an identifier (vehicle ID) of the vehicle 10 that is a target of remote control, information indicating the user-specified mode (information that specifies the first mode or the second mode), and the execution condition for the user-specified mode (first threshold or second threshold).

The server 30 is one or more computers that relay signals related to the remote air conditioning between the user terminal 20 and the vehicle 10. The server 30 in the present embodiment has a function of transmitting, to the vehicle 10 that is the target of remote control, a command (operation command) in response to the execution request received from the user terminal 20. For example, the operation command may include, as shown in FIG. 3, the user-specified mode (information that specifies the first mode or the second mode) and the execution condition for the user-specified mode. In the present embodiment, the server 30 corresponds to an “external device related to the vehicle” according to the present disclosure.

In the system of the present embodiment, the user inputs an operation to select execution of a user-specified mode into the terminal before getting into the parked vehicle 10 (the power switch or the ignition switch is OFF). The user terminal 20 to which the operation is input transmits, to the server 30, an execution request for the remote air conditioning in the user-specified mode (see FIG. 2). The server 30 that receives the execution request identifies the vehicle 10 that is a target of the remote air conditioning based on a vehicle ID in the execution request, and transmits an operation command (see FIG. 3) to the identified vehicle 10. The vehicle 10 that receives the operation command determines whether an execution condition in the operation command is satisfied. When determination is made that the execution condition is satisfied, the air conditioner 120 of the vehicle 10 is operated in the user-specified mode. When determination is made that the execution condition is not satisfied, the air conditioner 120 of the vehicle 10 is not operated in the user-specified mode. When determination is made that the execution condition is not satisfied, information indicating that the execution condition is not satisfied may be transmitted from the vehicle 10 to the user terminal 20 via the server 30.

### System Hardware Configuration

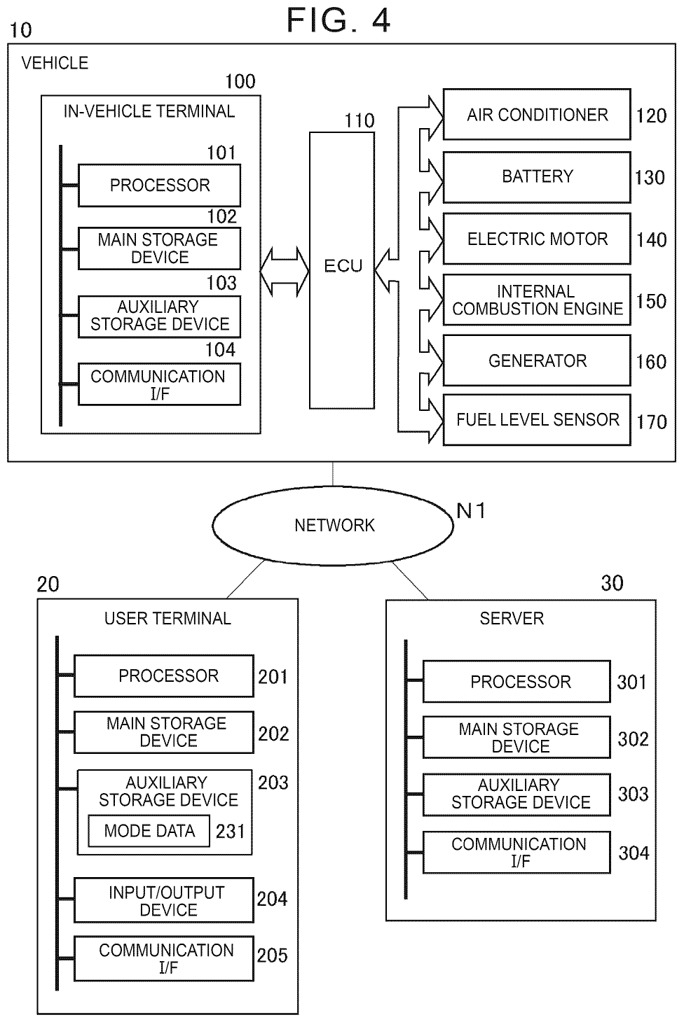

The hardware configurations of the vehicle 10, the user terminal 20, and the server 30 in the system of the present embodiment will be described with reference to FIG. 4. FIG. 4 is a diagram schematically showing an example of the hardware configurations of the vehicle 10, the user terminal 20, and the server 30 in the system of the present embodiment.

### Vehicle

First, an example of the hardware configuration of the vehicle 10 will be described. As described above, the vehicle 10 in the present embodiment is an HEV or a PHEV. As shown in FIG. 4, the vehicle 10 includes an in-vehicle terminal 100, an electronic control unit (ECU) 110, the air conditioner 120, the battery 130, the electric motor 140, the internal combustion engine 150, the generator 160, and a fuel level sensor 170. The in-vehicle terminal 100, the ECU 110, the air conditioner 120, the battery 130, the electric motor 140, the internal combustion engine 150, the generator 160, and the fuel level sensor 170 are connected to each other via an in-vehicle network based on a standard such as a controller area network (CAN), a local interconnect network (LIN), or FlexRay.

In FIG. 4, only the hardware components related to the remote air conditioning are extracted in the illustration, and hardware components other than the hardware components shown in FIG. 4 may be mounted on the vehicle 10.

The in-vehicle terminal 100 is a computer that communicates with the server 30 via a network N1. As shown in FIG. 4, the in-vehicle terminal 100 includes a processor 101, a main storage device 102, an auxiliary storage device 103, and a communication interface (I/F) 104. The processor 101, the main storage device 102, the auxiliary storage device 103, and the communication I/F 104 are connected to each other via a bus.

The processor 101 is an arithmetic processing device such as a central processing unit (CPU), a graphics processing unit (GPU), or a digital signal processor (DSP). The processor 101 controls the in-vehicle terminal 100 by loading a program stored in the auxiliary storage device 103 into the main storage device 102 and executing the program.

The main storage device 102 includes semiconductor memories such as a random access memory (RAM) and a read only memory (ROM). The main storage device 102 provides a storage area and a working area for loading programs stored in the auxiliary storage device 103. The main storage device 102 is used as a buffer for arithmetic processing executed by the processor 101.

The auxiliary storage device 103 is, for example, an erasable programmable ROM (EPROM) or a hard disk drive (HDD). The auxiliary storage device 103 may include a removable medium, that is, a portable recording medium. The removable medium is a disk recording medium such as a universal serial bus (USB) memory, a compact disc (CD), or a digital versatile disc (DVD). The auxiliary storage device 103 stores, for example, various programs and data to be used by the processor 101 to execute the programs.

The programs stored in the auxiliary storage device 103 include an operating system (OS), a dedicated program for causing the processor 101 to execute processes related to the remote air conditioning, the vehicle ID of the vehicle 10, etc. Part or all of the information stored in the auxiliary storage device 103 may be stored in the main storage device 102. Part of the information stored in the main storage device 102 may be stored in the auxiliary storage device 103. The vehicle ID may be held by the ECU 110 described later.

The communication I/F 104 includes a communication interface for connecting the in-vehicle terminal 100 to the in-vehicle network, and a communication interface for connecting the in-vehicle terminal 100 to the external network N1. In the present embodiment, the communication I/F 104 communicates with the ECU 110 via the in-vehicle network. In the present embodiment, the communication I/F 104 communicates with the server 30 via the external network N1. The external network N1 is, for example, a wide area network (WAN) that is a global public communication network such as the Internet, or any other communication network. The communication I/F 104 connects the in-vehicle terminal 100 to the network N1 by a mobile communication scheme (e.g., 5th Generation (5G) or 6th Generation (6G)) or a wireless communication scheme such as Wi-Fi (registered trademark).

In the in-vehicle terminal 100 configured as described above, when the communication I/F 104 receives an operation command (see FIG. 3) transmitted from the server 30, the processor 101 determines whether an execution condition in the operation command is satisfied. When a user-specified mode in the operation command is the first mode, the processor 101 of the in-vehicle terminal 100 is connected to the in-vehicle network via the communication I/F 104 and communicates with the ECU 110 via the in-vehicle network to acquire the remaining battery charge level (SOC). The processor 101 determines whether the acquired remaining battery charge level (SOC) is equal to or greater than the first threshold in the operation command. When the user-specified mode in the operation command is the second mode, the processor 101 of the in-vehicle terminal 100 is connected to the in-vehicle network via the communication I/F 104 and communicates with the ECU 110 via the in-vehicle network to acquire the remaining fuel level. The processor 101 determines whether the acquired remaining fuel level is equal to or greater than the second threshold in the operation command.

When the remaining battery charge level (SOC) is equal to or greater than the first threshold or the remaining fuel level is equal to or greater than the second threshold, the processor 101 of the in-vehicle terminal 100 determines that the execution condition for the user-specified mode is satisfied. In this case, the processor 101 of the in-vehicle terminal 100 transmits a command to operate the air conditioner 120 in the user-specified mode to the ECU 110 via the communication I/F 104 and the in-vehicle network.

The determination as to whether the execution condition in the operation command is satisfied may be made by the ECU 110 described later. In this case, the in-vehicle terminal 100 may transmit the operation command received from the server 30 to the ECU 110 via the communication I/F 104 and the in-vehicle network.

Next, the air conditioner 120 is an electric air conditioner that uses electric power of the battery 130 to cool or heat a vehicle cabin of the vehicle 10. The battery 130 supplies electric power to the electric motor 140 and the air conditioner 120. The electric motor 140 is operated using the electric power supplied from the battery 130. The internal combustion engine 150 is operated using fuel stored in a fuel tank mounted on the vehicle 10. In one example, the electric motor 140 and the internal combustion engine 150 may cooperate to drive the vehicle 10. In another example, the electric motor 140 may drive the vehicle 10, and the internal combustion engine 150 may drive the generator 160 described later to charge the battery 130. The generator 160 generates electric power by converting kinetic energy generated by the internal combustion engine 150 into electric energy. The generator 160 may perform so-called regenerative power generation in which the kinetic energy of drive wheels is converted into electric energy when the vehicle 10 is decelerating. The fuel level sensor 170 measures the amount of fuel (remaining fuel level) stored in the fuel tank.

The ECU 110 is a computer that controls in-vehicle devices such as the air conditioner 120, the electric motor 140, the internal combustion engine 150, and the generator 160. In the present embodiment, the ECU 110 acquires the remaining battery charge level (SOC) or the remaining fuel level in response to a request from the in-vehicle terminal 100, and provides the acquired remaining battery charge level (SOC) or the acquired remaining fuel level to the in-vehicle terminal 100. At this time, the ECU 110 may calculate the remaining charge level (SOC) of the battery 130 using a known method such as an open circuit voltage (OCV) method or a current integration method. The ECU 110 may acquire the remaining fuel level in the fuel tank via the fuel level sensor 170.

The ECU 110 in the present embodiment also has a function of controlling the air conditioner 120 in response to a command transmitted from the in-vehicle terminal 100 to the ECU 110. Specifically, when the command is a command to operate the air conditioner 120 in the first mode, the ECU 110 operates the air conditioner 120 by supplying electric power from the battery 130 to the air conditioner 120. Thus, the remote air conditioning is executed in the first mode. When the command is a command to operate the air conditioner 120 in the second mode, the ECU 110 operates the internal combustion engine 150 and the generator 160 to charge the battery 130, and operates the air conditioner 120 by supplying electric power from the battery 130 to the air conditioner 120. Thus, the remote air conditioning is executed in the second mode.

### User Terminal

Next, an example of the hardware configuration of the user terminal 20 will be described. The user terminal 20 in the present embodiment is a computer that is used by the user of the vehicle 10. The user terminal 20 may be, for example, a smartphone, a tablet terminal, a wearable computer, or a personal computer (PC). The user terminal 20 may be a dedicated communication terminal adapted to the remote air conditioning. As shown in FIG. 4, the user terminal 20 in the present embodiment includes a processor 201, a main storage device 202, an auxiliary storage device 203, an input/output device 204, and a communication I/F 205. The processor 201, the main storage device 202, the auxiliary storage device 203, and the input/output device 204, and the communication I/F 205 are connected to each other via a bus.

In FIG. 4, only the hardware components related to the remote air conditioning are extracted in the illustration, and hardware components other than the hardware components shown in FIG. 4 may be included in the user terminal 20.

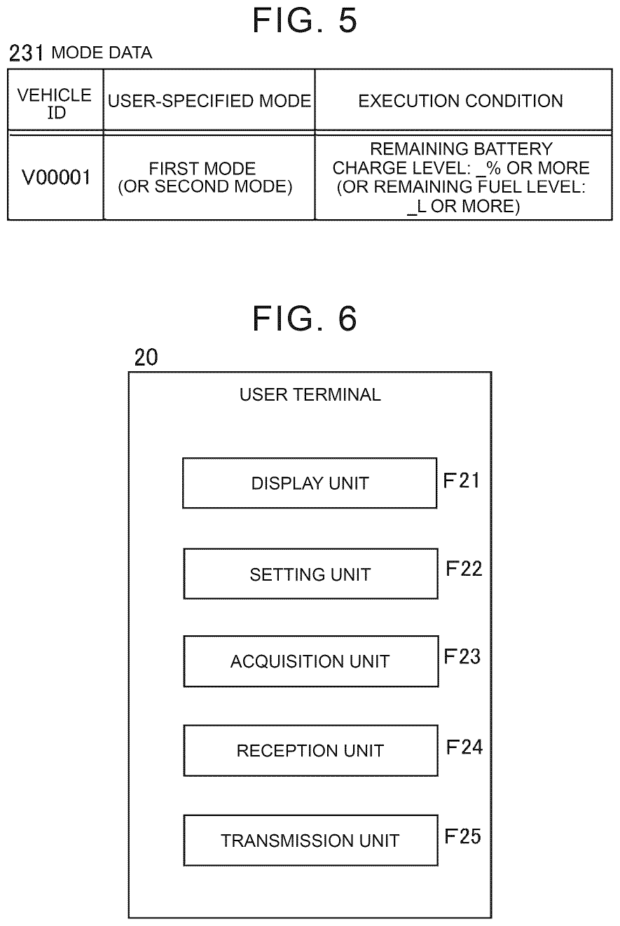

The processor 201, the main storage device 202, and the auxiliary storage device 203 of the user terminal 20 are similar to the processor 101, the main storage device 102, and the auxiliary storage device 103 of the in-vehicle terminal 100, respectively, and therefore their description will be omitted. The auxiliary storage device 203 of the user terminal 20 stores a dedicated program (application program) for causing the processor 201 to execute functions related to the remote air conditioning, and mode data 231. For example, as shown in FIG. 5, the mode data 231 includes the vehicle ID of the vehicle 10, a user-specified mode preset by the user of the vehicle 10, and an execution condition (execution condition for the user-specified mode) preset by the user of the vehicle 10. In the present embodiment, the auxiliary storage device 203 that stores the mode data 231 corresponds to a “storage unit” according to the present disclosure.

The input/output device 204 receives an input manipulation performed by the user, and presents information to the user. The input/output device 204 includes, for example, a touch panel display and its control circuit.

The communication I/F 205 includes a communication interface for connecting the user terminal 20 to the network N1. The communication I/F 205 connects the user terminal 20 to the network N1 via a mobile communication scheme, a wireless communication scheme such as Wi-Fi (registered trademark), a local area network (LAN), etc. In the present embodiment, the communication I/F 205 communicates with the server 30 via the network N1.

In the user terminal 20 configured as described above, when an operation to activate the dedicated application program adapted to the remote air conditioning is input to the input/output device 204, the processor 201 interacts with the user through the execution of the application program, thereby setting a user-specified mode, setting an execution condition for the user-specified mode, transmitting an execution request for the remote air conditioning, etc. Details of setting the user-specified mode, setting the execution condition for the user-specified mode, and transmitting the execution request for the remote air conditioning will be described later.

### Server

Next, an example of the hardware configuration of the server 30 will be described. The server 30 in the present embodiment is a computer operated by a provider of the remote air conditioning service. The provider of the remote air conditioning service is, for example, a manufacturer of the vehicle 10 or a business operator commissioned by the manufacturer. As shown in FIG. 4, the server 30 includes a processor 301, a main storage device 302, an auxiliary storage device 303, and a communication I/F 304.

In FIG. 4, only the hardware components related to the remote air conditioning are extracted in the illustration, and hardware components other than the hardware components shown in FIG. 4 may be included in the server 30.

The processor 301, the main storage device 302, and the auxiliary storage device 303 of the server 30 are similar to the processor 101, the main storage device 102, and the auxiliary storage device 103 of the in-vehicle terminal 100, respectively, and therefore their description will be omitted. The auxiliary storage device 303 of the server 30 stores, in addition to an OS, a dedicated program for causing the processor 301 to execute processes related to the remote air conditioning.

The communication I/F 304 of the server 30 is a communication interface for connecting the server 30 to the network N1. In one example, the communication I/F 304 may include a network interface board and a wireless communication interface for wireless communication. In the present embodiment, the communication I/F 304 communicates with the user terminal 20 and the in-vehicle terminal 100 via the network N1.

In the server 30 configured as described above, when the communication I/F 304 receives an execution request transmitted from the user terminal 20, the processor 301 identifies the vehicle 10 that is a target of the execution request based on the vehicle ID in the execution request. The processor 301 transmits an operation command to the in-vehicle terminal 100 of the identified vehicle 10 via the communication I/F 304. As described above, the operation command may include a user-specified mode (information that specifies the first mode or the second mode) and an execution condition for the user-specified mode (see FIG. 3).

### Software Configuration of User Terminal

Next, the software configuration of the user terminal 20 will be described with reference to FIG. 6. FIG. 6 is a block diagram schematically showing an example of the software configuration of the user terminal 20. The user terminal 20 operates as a computer including a display unit F21, a setting unit F22, an acquisition unit F23, a reception unit F24, and a transmission unit F25 as software modules by the processor 201 executing a program stored in the auxiliary storage device 203.

At least part of the display unit F21, the setting unit F22, the acquisition unit F23, the reception unit F24, and the transmission unit F25 may be implemented by a hardware circuit such as an application specific integrated circuit (ASIC) or a field programmable gate array (FPGA).

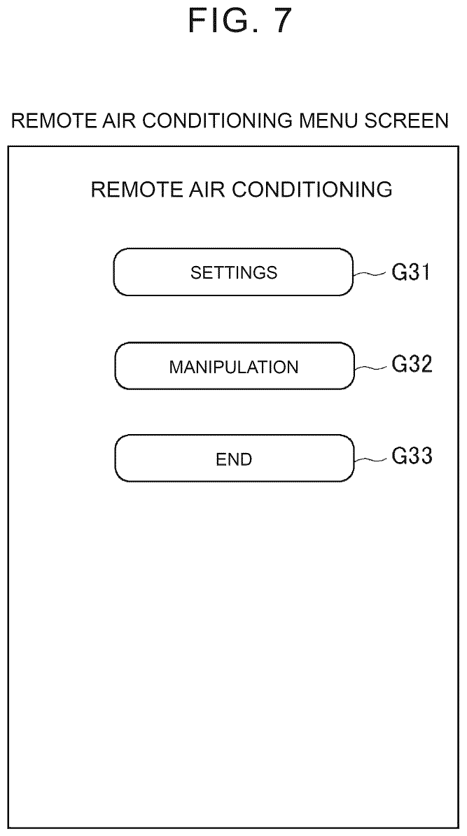

The display unit F21 causes the input/output device 204 to output a remote air conditioning menu screen in response to the activation of the dedicated application program adapted to the remote air conditioning. In one example, the remote air conditioning menu screen may include, as shown in FIG. 7, a setting button G31 that is a graphical user interface (GUI) component for calling setting screens for a user-specified mode and an execution condition, an operation button G32 that is a GUI component for calling an operation reception screen for the remote air conditioning, and a termination button G33 that is a GUI component for terminating execution of the application program. The configuration of the remote air conditioning menu screen is not limited to the example shown in FIG. 7, and may be changed as appropriate depending on embodiments.

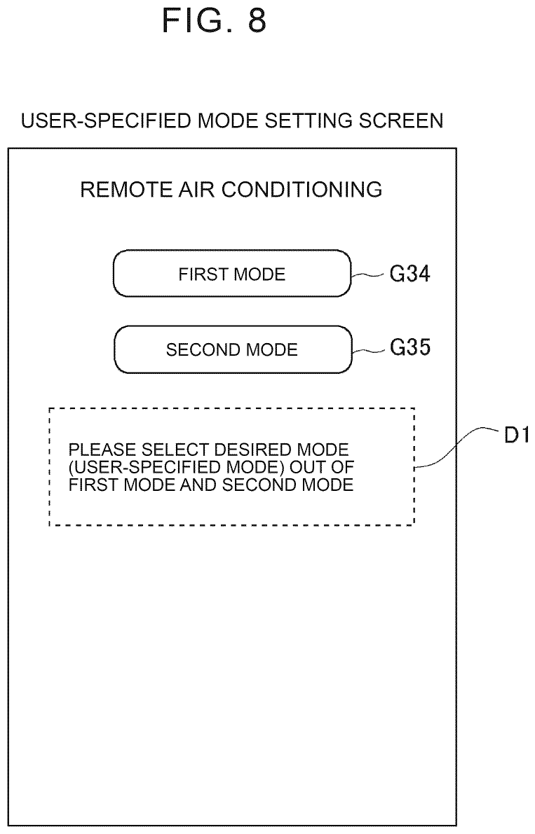

The setting unit F22 causes the input/output device 204 to output a setting screen when the remote air conditioning menu screen is displayed and an operation to select the setting button G31 (e.g., tap or click) is input to the input/output device 204. In the present embodiment, the setting unit F22 first causes the input/output device 204 to output a user-specified mode setting screen. In one example, the user-specified mode setting screen may include, as shown in FIG. 8, a first mode button G34 that is a GUI component for setting the first mode as the user-specified mode, a second mode button G35 that is a GUI component for setting the second mode as the user-specified mode, and a display field D1 for a message that prompts the selection of the user-specified mode. In the present embodiment, the user-specified mode setting screen corresponds to a “second screen” according to the present disclosure.

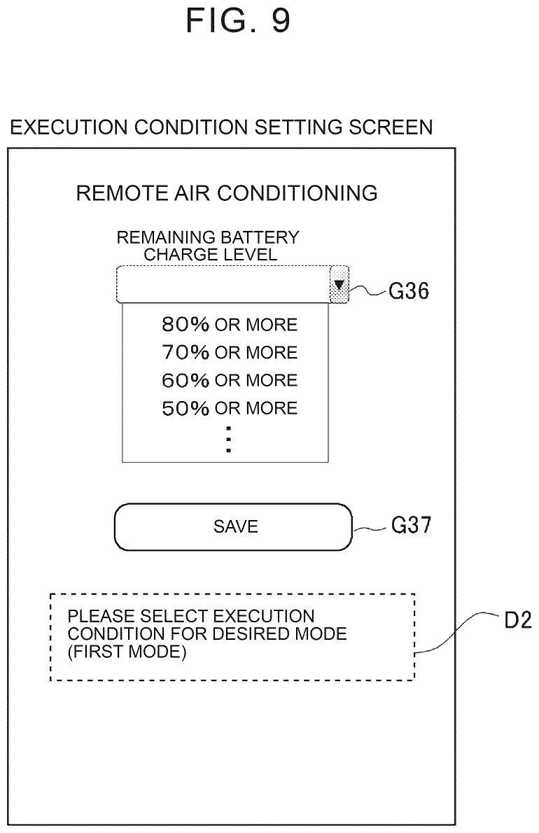

When the user-specified mode setting screen (see FIG. 8) is displayed and an operation to select the first mode button G34 (e.g., tap or click) is input to the input/output device 204, the setting unit F22 causes the input/output device 204 to output an execution condition setting screen associated with the first mode. In one example, the execution condition setting screen associated with the first mode may include, as shown in FIG. 9, a pull-down menu G36 that is a GUI component for selecting a lower limit value of the remaining battery charge level, a save button G37 that is a GUI component for saving the selected lower limit value of the remaining battery charge level, and a display field D2 for a message that prompts the selection of the execution condition for the first mode (lower limit value of the remaining battery charge level). The execution condition setting screen associated with the first mode may include an input field for the user to input any remaining battery charge level instead of the pull-down menu G36.

When the user selects a desired remaining battery charge level from the pull-down menu G36 on the execution condition setting screen associated with the first mode and then an operation to select the save button G37 (e.g., tap or click) is input to the input/output device 204, the setting unit F22 generates mode data 231 and stores the generated mode data 231 in the auxiliary storage device 203. In this case, the mode data 231 includes information indicating that the user-specified mode is the first mode, and information indicating that the execution condition is the lower limit value of the remaining battery charge level selected on the execution condition setting screen.

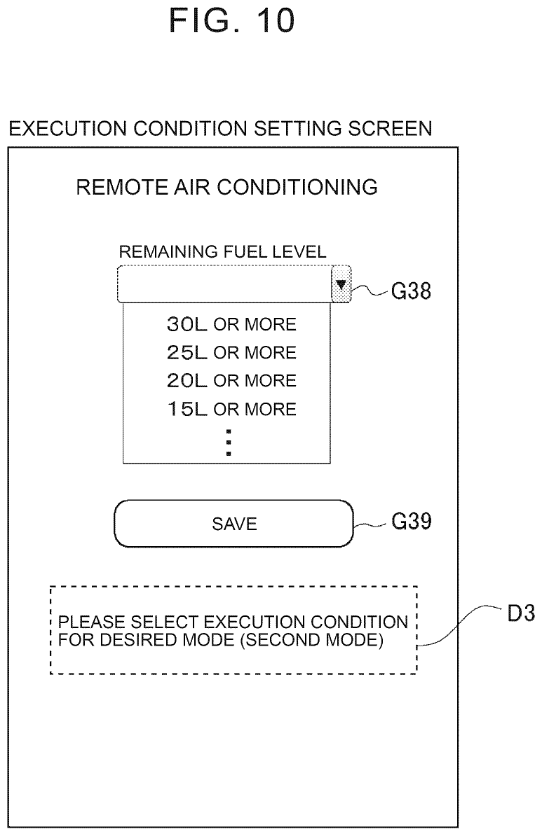

When the user-specified mode setting screen (see FIG. 8) is displayed and an operation to select the second mode button G35 (e.g., tap or click) is input to the input/output device 204, the setting unit F22 causes the input/output device 204 to output an execution condition setting screen associated with the second mode. In one example, the execution condition setting screen associated with the second mode may include, as shown in FIG. 10, a pull-down menu G38 that is a GUI component for selecting a lower limit value of the remaining fuel level, a save button G39 that is a GUI component for saving the selected lower limit value of the remaining fuel level, and a display field D3 for a message that prompts the selection of the execution condition for the second mode (lower limit value of the remaining fuel level). The execution condition setting screen associated with the second mode may include an input field for the user to input any remaining fuel level instead of the pull-down menu G38.

When the user selects a desired remaining fuel level from the pull-down menu G38 on the execution condition setting screen associated with the second mode and then an operation to select the save button G39 (e.g., tap or click) is input to the input/output device 204, the setting unit F22 generates mode data 231 and stores the generated mode data 231 in the auxiliary storage device 203. In this case, the mode data 231 includes information indicating that the user-specified mode is the second mode, and information indicating that the execution condition is the lower limit value of the remaining fuel level selected on the execution condition setting screen.

In the present embodiment, the execution condition setting screen associated with the first mode and the execution condition setting screen associated with the second mode correspond to a “third screen” according to the present disclosure.

The acquisition unit F23 accesses the mode data 231 in the auxiliary storage device 203 to acquire the vehicle ID, the user-specified mode, and the execution condition for the user-specified mode when the remote air conditioning menu screen (see FIG. 7) is displayed and an operation to select the operation button G32 (e.g., tap or click) is input to the input/output device 204.

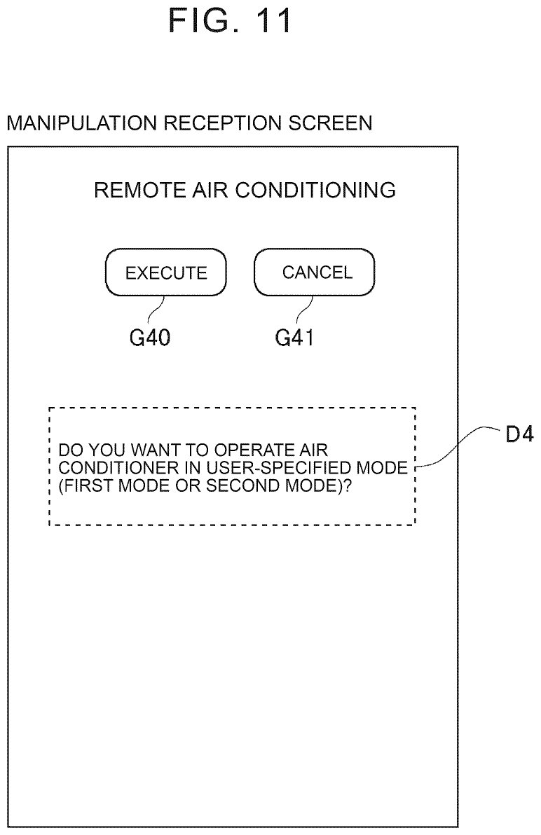

The reception unit F24 causes the input/output device 204 to output an operation reception screen when the acquisition unit F23 acquires the vehicle ID, the user-specified mode, and the execution condition for the user-specified mode. In one example, the operation reception screen may include, as shown in FIG. 11, an execution button G40 that is a GUI component for transmitting an execution request for the user-specified mode, a cancellation button G41 that is a GUI component for canceling the operation for the remote air conditioning, and a display field D4 for a message that prompts the selection as to whether to operate the air conditioner 120 in the user-specified mode. The message displayed in the display field D4 may be changed depending on the user-specified mode acquired by the acquisition unit F23. For example, when the user-specified mode acquired by the acquisition unit F23 is the first mode, a message that prompts the selection as to whether to operate the air conditioner 120 in the first mode may be displayed in the display field D4. When the user-specified mode acquired by the acquisition unit F23 is the second mode, a message that prompts the selection as to whether to operate the air conditioner 120 in the second mode may be displayed in the display field D4. In addition to the above message, the display field D4 may also display the execution condition set by the setting unit F22. The configuration of the operation reception screen is not limited to the example shown in FIG. 11, and may be changed as appropriate depending on embodiments.

For example, the operation reception screen may further include a GUI component for setting the room temperature of the vehicle 10 and/or a GUI component for setting the execution time of the user-specified mode. In the present embodiment, the operation reception screen corresponds to a “first screen” according to the present disclosure.

The transmission unit F25 transmits an execution request to the server 30 when the operation reception screen is displayed and an operation to select the execution button G40 (e.g., tap or click) is input to the input/output device 204. As described above, the execution request is a signal including the vehicle ID, the user-specified mode, and the execution condition for the user-specified mode (see FIG. 2). The execution request is generated using the vehicle ID, the user-specified mode, and the execution condition for the user-specified mode acquired by the acquisition unit F23. The transmission unit F25 transmits the generated execution request to the server 30 via the communication I/F 205.

The software configuration of the user terminal 20 is not limited to the example shown in FIG. 6, and any software component may be added, omitted, or modified depending on embodiments.

### Processing Flow

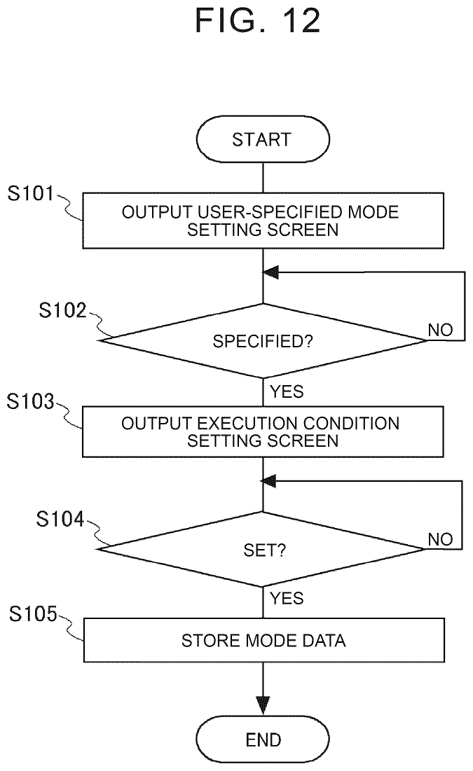

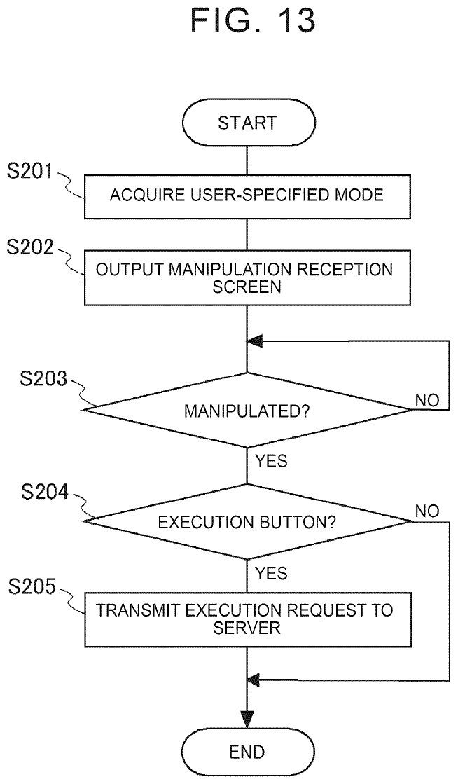

Next, processing flows to be executed by the user terminal 20 in the present embodiment will be described with reference to FIGS. 12 and 13. FIG. 12 is a flowchart showing a processing flow to be executed by the user terminal 20 when a user-specified mode and an execution condition are set. FIG. 13 is a flowchart showing a processing routine to be executed by the user terminal 20 when an operation for the remote air conditioning is received. The main executor of the processing routines of FIGS. 12 and 13 is the processor 201 of the user terminal 20, but description will be given under the assumption that the main executor is each of the software components of the user terminal 20.

The processing routine of FIG. 12 is executed when the remote air conditioning menu screen (see FIG. 7) is displayed and the setting button G31 is manipulated. In the processing routine of FIG. 12, the processor 201 of the user terminal 20 operates as the setting unit F22 in response to the operation of the setting button G31, and causes the input/output device 204 to output the user-specified mode setting screen (step S101). As described with reference to FIG. 8, the user-specified mode setting screen may include the first mode button G34 that is the GUI component for setting the first mode as the user-specified mode, the second mode button G35 that is the GUI component for setting the second mode as the user-specified mode, and the display field D1 for the message that prompts the selection of the user-specified mode. When the process of step S101 is finished, the setting unit F22 executes a process of step S102.

In step S102, the setting unit F22 determines whether either the first mode or the second mode is specified on the user-specified mode setting screen. In one example, the setting unit F22 determines whether an operation to select either the first mode button G34 or the second mode button G35 is input to the input/output device 204 while the user-specified mode setting screen shown in FIG. 8 is displayed. When the operation to select either the first mode button G34 or the second mode button G35 is not input to the input/output device 204 (negative determination in step S102), the setting unit F22 waits until the operation is input to the input/output device 204. When the operation to select either the first mode button G34 or the second mode button G35 is input to the input/output device 204 (positive determination in step S102), the setting unit F22 executes a process of step S103.

In step S103, the input/output device 204 outputs an execution condition setting screen associated with the mode specified on the user-specified mode setting screen. When the first mode is specified as the user-specified mode on the user-specified mode setting screen (e.g., when the first mode button G34 in FIG. 8 is manipulated), the setting unit F22 causes the input/output device 204 to output the execution condition setting screen associated with the first mode as described with reference to FIG. 9. When the second mode is specified as the user-specified mode on the user-specified mode setting screen (e.g., when the second mode button G35 in FIG. 8 is manipulated), the setting unit F22 causes the input/output device 204 to output the execution condition setting screen associated with the second mode as described with reference to FIG. 10. When the process of step S103 is finished, the setting unit F22 executes a process of step S104.

In step S104, the setting unit F22 determines whether an execution condition for the user-specified mode is set. When the first mode is specified as the user-specified mode, the setting unit F22 determines whether an operation to select the save button G37 is input to the input/output device 204 after the user selects the desired remaining battery charge level from the pull-down menu G36 on the execution condition setting screen associated with the first mode shown in FIG. 9. When the second mode is specified as the user-specified mode, the setting unit F22 determines whether an operation to select the save button G39 is input to the input/output device 204 after the user selects the desired remaining fuel level from the pull-down menu G38 on the execution condition setting screen associated with the second mode shown in FIG. 10. When the execution condition for the user-specified mode is not set (negative determination in step S104), the setting unit F22 waits until the execution condition for the user-specified mode is set. When the execution condition for the user-specified mode is set (positive determination in step S104), the setting unit F22 executes a process of step S105.

In step S105, the setting unit F22 generates mode data 231 including the user-specified mode set on the user-specified mode setting screen, the execution condition set on the execution condition setting screen, and the vehicle ID, and stores the generated mode data 231 in the auxiliary storage device 203. When the setting unit F22 finishes the process of step S105, the processor 201 of the user terminal 20 terminates the execution of the processing routine of FIG. 12.

Next, the processing routine of FIG. 13 is executed when the remote air conditioning menu screen (see FIG. 7) is displayed and the operation button G32 is manipulated. It is assumed that the processing routine of FIG. 12 has been executed in advance (the user-specified mode and the execution condition have been set).

In the processing routine of FIG. 13, the processor 201 of the user terminal 20 operates as the acquisition unit F23 in response to the operation of the operation button G32, and acquires the user-specified mode (step S201). Specifically, the acquisition unit F23 accesses the mode data 231 in the auxiliary storage device 203, and acquires the vehicle ID, the user-specified mode, and the execution condition for the user-specified mode. When the acquisition unit F23 finishes the process of step S201, the processor 201 of the user terminal 20 operates as the reception unit F24 and executes a process of step S202.

In step S202, the reception unit F24 causes the input/output device 204 to output the operation reception screen. As described with reference to FIG. 11, the operation reception screen may include the execution button G40 that is the GUI component for transmitting an execution request for the user-specified mode, the cancellation button G41 that is the GUI component for canceling the operation for the remote air conditioning, and the display field D4 for the message that prompts the selection as to whether to operate the air conditioner 120 in the user-specified mode. At this time, the message displayed in the display field D4 may be changed depending on the user-specified mode acquired by the acquisition unit F23. When the process of step S202 is finished, the reception unit F24 executes a process of step S203.

In step S203, the reception unit F24 determines whether a selection is made on the operation reception screen as to whether to execute the user-specified mode. In one example, the reception unit F24 determines whether an operation to select either the execution button G40 or the cancellation button G41 is input to the input/output device 204 while the operation reception screen shown in FIG. 11 is displayed. When the operation to select either the execution button G40 or the cancellation button G41 is not input to the input/output device 204 (negative determination in step S203), the reception unit F24 waits until the operation is input to the input/output device 204. When the operation to select either the execution button G40 or the cancellation button G41 is input to the input/output device 204 (positive determination in step S203), the reception unit F24 executes a process of step S204.

In step S204, the reception unit F24 determines whether the operation input to the input/output device 204 while the operation reception screen is displayed is an operation to select the execution button G40. When the operation input to the input/output device 204 while the operation reception screen is displayed is an operation to select the cancellation button G41 (negative determination in step S204), the processor 201 of the user terminal 20 terminates the execution of the processing routine of FIG. 13. When the operation input to the input/output device 204 while the operation reception screen is displayed is an operation to select the execution button G40 (positive determination in step S204), the processor 201 of the user terminal 20 operates as the transmission unit F25 and executes a process of step S205.

In step S205, the transmission unit F25 transmits an execution request to the server 30. Specifically, the transmission unit F25 first generates an execution request using the vehicle ID, the user-specified mode, and the execution condition for the user-specified mode acquired by the acquisition unit F23. Then, the transmission unit F25 transmits the generated execution request to the server 30 via the communication I/F 205. When the transmission unit F25 finishes the process of step S205, the processor 201 of the user terminal 20 terminates the execution of the processing routine of FIG. 13.

### Functions and Effects of Embodiment

In the above embodiment, the user terminal 20 sets the first mode or the second mode as the user-specified mode desired by the user. When an operation to execute the remote air conditioning is input, the user terminal 20 transmits, to the server 30, a request (execution request) to execute the remote air conditioning in the user-specified mode desired by the user. The server 30 transmits an operation command to the vehicle 10 that is the target of the execution request to operate the air conditioner 120 in the user-specified mode. Thus, the air conditioner 120 of the vehicle 10 can be operated in the first mode or the second mode desired by the user. As a result, it is possible to suppress execution of the remote air conditioning in a mode that is not intended by the user. As a result, the convenience for the user who uses the remote air conditioning can be secured.

In the present embodiment, the user terminal 20 sets the execution condition for the user-specified mode as desired by the user. The user terminal 20 transmits the execution request including the execution condition desired by the user to the server 30. The server 30 transmits the operation command including the execution condition to the vehicle 10 that is the target of the execution request. The vehicle 10 operates the air conditioner 120 in the user-specified mode only when the execution condition in the operation command is satisfied. Thus, it is possible to avoid a situation in which the remaining battery charge level or the remaining fuel level of the vehicle 10 is less than that expected by the user due to the remote air conditioning executed in the user-specified mode.

### First Modification

The above embodiment illustrates the example in which the air conditioner 120 undergoes remote control in accordance with the user-specified mode preset by the user. The first modification illustrates an example in which the user-specified mode is set every time the air conditioner 120 undergoes remote control. Configurations different from those in the above embodiment will be described, and description will be omitted for similar configurations.

### Software Configuration of User Terminal

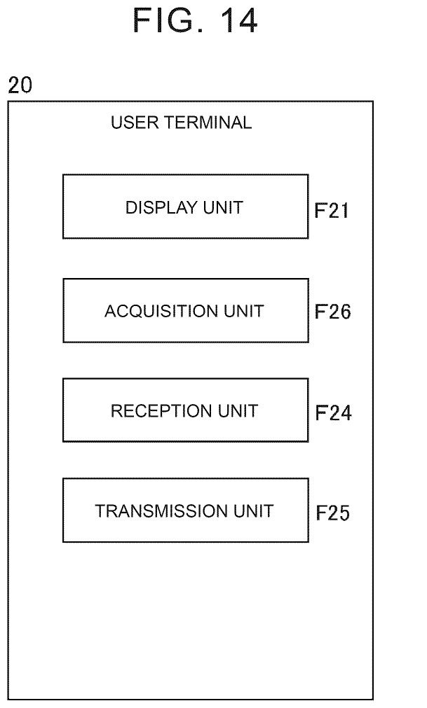

FIG. 14 is a block diagram schematically showing an example of the software configuration of the user terminal 20 according to the first modification. The user terminal 20 in the first modification operates as a computer including the display unit F21, an acquisition unit F26, the reception unit F24, and the transmission unit F25 as software modules by the processor 201 executing a program stored in the auxiliary storage device 203.

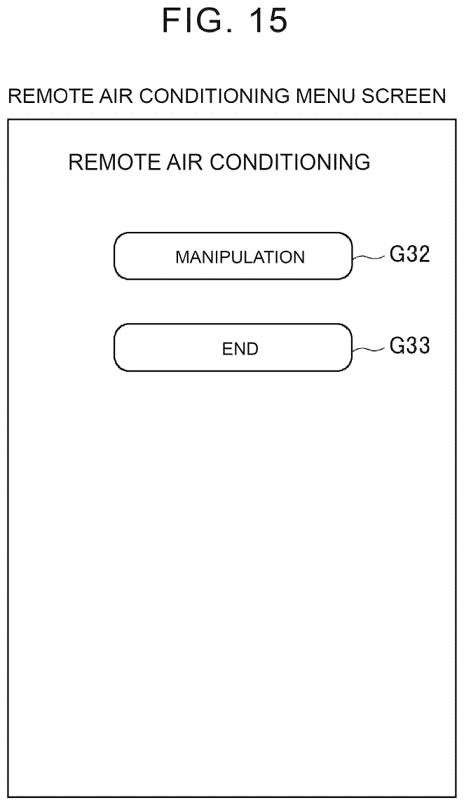

The display unit F21 in the present modification causes the input/output device 204 to output a remote air conditioning menu screen shown in FIG. 15 in response to the activation of the dedicated application program adapted to the remote air conditioning. The remote air conditioning menu screen illustrated in FIG. 15 does not include the GUI component for calling the setting screens for a user-specified mode and an execution condition (e.g., the setting button G31 in FIG. 7) but includes the operation button G32 that is the GUI component for calling the operation reception screen for the remote air conditioning, and the termination button G33 that is the GUI component for terminating the execution of the application program.

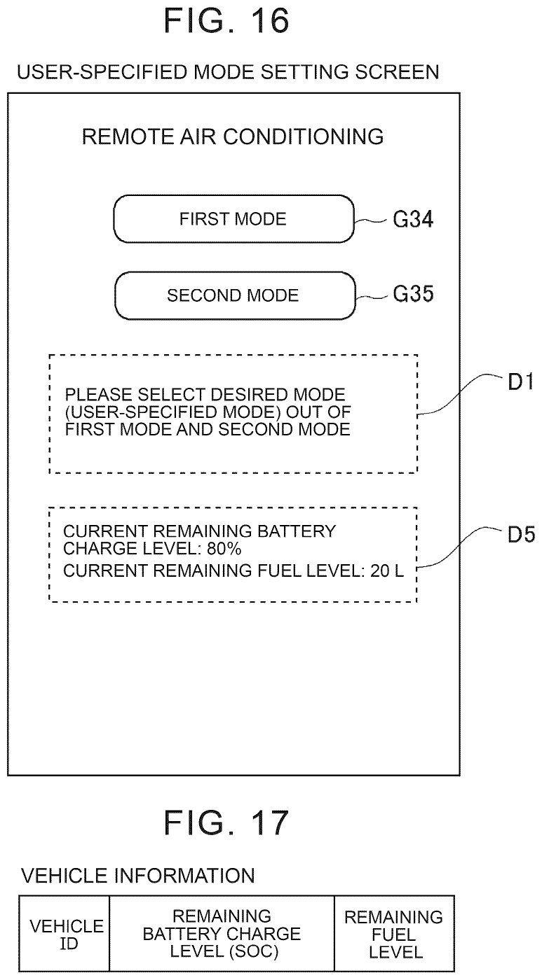

The acquisition unit F26 in the present modification causes the input/output device 204 to output a user-specified mode setting screen when the remote air conditioning menu screen shown in FIG. 15 is displayed and an operation to select the operation button G32 is input to the input/output device 204. In one example, the user-specified mode setting screen in the first modification may include, as shown in FIG. 16, a display field D5 for the current remaining battery charge level and the current remaining fuel level of the vehicle 10 in addition to the first mode button G34 that is the GUI component for setting the first mode as the user-specified mode, the second mode button G35 that is the GUI component for setting the second mode as the user-specified mode, and the display field D1 for the message that prompts the selection of the user-specified mode. The mode setting screen in the first modification corresponds to a “fourth screen” according to the present disclosure.

When the user-specified mode setting screen illustrated in FIG. 16 is output to the input/output device 204, the acquisition unit F26 may transmit a vehicle information request to the server 30. A vehicle information request signal is a signal for requesting the remaining battery charge level and the remaining fuel level of the vehicle 10, and includes the vehicle ID of the vehicle 10.

In the server 30 that receives the vehicle information request, the processor 301 identifies the vehicle 10 that is a target of the vehicle information request based on the vehicle ID in the vehicle information request. The processor 301 of the server 30 transmits a vehicle information transmission command to the in-vehicle terminal 100 of the identified vehicle 10 via the communication I/F 304.

In the in-vehicle terminal 100 that receives the vehicle information transmission command, the processor 101 is connected to the in-vehicle network via the communication I/F 104 and communicates with the ECU 110 via the in-vehicle network to acquire the remaining charge level (SOC) of the battery 130 and the remaining fuel level in the fuel tank. The processor 101 of the in-vehicle terminal 100 generates vehicle information including the data acquired from the ECU 110. In one example, the vehicle information may include the vehicle ID, the remaining charge level (SOC) of the battery 130, and the remaining fuel level in the fuel tank as shown in FIG. 17. When the vehicle information is generated, the processor 101 of the in-vehicle terminal 100 is connected to the external network N1 via the communication I/F 104, and transmits the vehicle information to the server 30 via the network N1.

In the server 30 that receives the vehicle information transmitted from the in-vehicle terminal 100, the processor 301 transmits the received vehicle information to the user terminal 20 via the communication I/F 304. In the user terminal 20 that receives the vehicle information transmitted from the server 30, the acquisition unit F26 causes the input/output device 204 to output the user-specified mode setting screen illustrated in FIG. 16.

When the user-specified mode setting screen is displayed and an operation to select either the first mode button G34 or the second mode button G35 is input to the input/output device 204, the acquisition unit F26 causes the input/output device 204 to output an execution condition setting screen associated with the mode specified as the user-specified mode (e.g., the execution condition setting screen illustrated in FIG. 9 or 10). When the user-specified mode is the first mode, the execution condition setting screen associated with the first mode may include a display field for the current remaining battery charge level. When the user-specified mode is the second mode, the execution condition setting screen associated with the second mode may include a display field for the current remaining fuel level. The execution condition setting screen in the first modification corresponds to a “fifth screen” according to the present disclosure.

The reception unit F24 in the first modification causes the input/output device 204 to output an operation reception screen when an execution condition is set on the execution condition setting screen associated with the mode specified as the user-specified mode. The operation reception screen in this case may be similar to that in the above embodiment (see FIG. 11).

As in the above embodiment, the transmission unit F25 in the first modification transmits an execution request to the server 30 when the operation reception screen is displayed and an operation to select the execution button G40 is input to the input/output device 204.

### Processing Flow

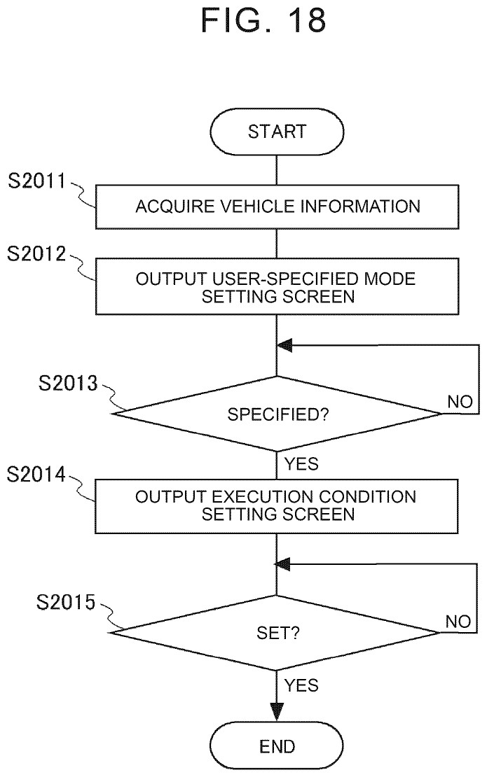

In the user terminal 20 in the first modification, a processing routine similar to that in FIG. 13 is executed when the remote air conditioning menu screen (see FIG. 15) is displayed and the operation button G32 is manipulated. Instead of the process of step S201 in FIG. 13, processes of steps S2011 to S2015 shown in FIG. 18 are executed.

In FIG. 18, when the remote air conditioning menu screen (see FIG. 15) is displayed and the operation button G32 is manipulated, the processor 201 of the user terminal 20 operates as the acquisition unit F26 and acquires vehicle information of the vehicle 10 (step S2011). In one example, the acquisition unit F26 transmits a vehicle information request to the server 30 via the communication I/F 205. When the vehicle information transmitted from the server 30 in response to this is received by the communication I/F 205 of the user terminal 20, the acquisition unit F26 executes the process of step S2012.

In step S2012, the acquisition unit F26 causes the input/output device 204 to output the user-specified mode setting screen. In one example, the user-specified mode setting screen in the first modification may include, as shown in FIG. 16, the display field D5 for the current remaining battery charge level and the current remaining fuel level of the vehicle 10 in addition to the first mode button G34 that is the GUI component for setting the first mode as the user-specified mode, the second mode button G35 that is the GUI component for setting the second mode as the user-specified mode, and the display field D1 for the message that prompts the selection of the user-specified mode. The remaining battery charge level and the remaining fuel level displayed in the display field D5 are the remaining battery charge level and the remaining fuel level in the vehicle information acquired in step S2011. When the process of step S2012 is finished, the acquisition unit F26 executes the process of step S2013.

In step S2013, the acquisition unit F26 determines whether an operation to select either the first mode button G34 or the second mode button G35 is input to the input/output device 204 while the user-specified mode setting screen illustrated in FIG. 16 is displayed. When the operation to select either the first mode button G34 or the second mode button G35 is not input to the input/output device 204 (negative determination in step S2013), the acquisition unit F26 waits until the operation is input to the input/output device 204. When the operation to select either the first mode button G34 or the second mode button G35 is input to the input/output device 204 (positive determination in step S2013), the acquisition unit F26 executes the process of step S2014.

In step S2014, the acquisition unit F26 causes the input/output device 204 to output an execution condition setting screen associated with the mode specified on the user-specified mode setting screen. When the first mode is specified as the user-specified mode on the user-specified mode setting screen (e.g., when the first mode button G34 in FIG. 16 is manipulated), the acquisition unit F26 causes the input/output device 204 to output the execution condition setting screen associated with the first mode (e.g., a screen similar to that in FIG. 9). When the second mode is specified as the user-specified mode on the user-specified mode setting screen (e.g., when the second mode button G35 in FIG. 16 is manipulated), the acquisition unit F26 causes the input/output device 204 to output the execution condition setting screen associated with the second mode (e.g., a screen similar to that in FIG. 10). When the process of step S2014 is finished, the acquisition unit F26 executes the process of step S2015.

In step S2015, the acquisition unit F26 determines whether an execution condition for the user-specified mode is set. When the execution condition for the user-specified mode is not set (negative determination in step S2015), the acquisition unit F26 waits until the execution condition for the user-specified mode is set. When the execution condition for the user-specified mode is set (positive determination in step S2015), the processor 201 of the user terminal 20 terminates the execution of the processing flow in FIG. 18 and executes processes similar to those of steps S202 to S205 in the processing routine in FIG. 13.

### Functions and Effects of First Modification

In the first modification, the user terminal 20 sets the user-specified mode and the execution condition when the remote control on the air conditioner 120 is received. At that time, the user terminal 20 presents the current remaining battery charge level and the current remaining fuel level to the user of the vehicle 10. Thus, the user of the vehicle 10 can set the user-specified mode and the execution condition by referring to the remaining battery charge level and the remaining fuel level at the time of remote control on the air conditioner 120.

### Second Modification

The second modification illustrates an example in which, after the remote air conditioning is executed, a battery charge amount or a fuel amount consumed by the execution of the remote air conditioning is presented to the user of the vehicle 10. Configurations different from those in the above embodiment will be described, and description will be omitted for similar configurations.

The in-vehicle terminal 100 in the second modification transmits actual record information to the server 30 when the execution of the remote air conditioning in the user-specified mode is finished. The actual record information includes the battery charge amount or the fuel amount consumed by the execution of the remote air conditioning. When the user-specified mode is the first mode, the actual record information includes the battery charge amount consumed by the execution of the first mode. When the user-specified mode is the second mode, the actual record information includes the fuel amount consumed by the execution of the second mode.

When transmitting the above actual record information to the server 30, the processor 101 of the in-vehicle terminal 100 first communicates with the ECU 110 via the communication I/F 104 to acquire the remaining battery charge level or the remaining fuel level at the start of the remote air conditioning and the remaining battery charge level or the remaining fuel level at the end of the remote air conditioning. Next, the processor 101 of the in-vehicle terminal 100 calculates a difference between the remaining battery charge levels (battery charge amount consumed by the execution of the remote air conditioning) or a difference between the remaining fuel levels (fuel amount consumed by the execution of the remote air conditioning) at the start and end of the remote air conditioning. The processor 101 of the in-vehicle terminal 100 transmits the actual record information including the calculated battery charge amount or the calculated fuel amount to the server 30 via the communication I/F 104.

The in-vehicle terminal 100 may generate actual record information including the remaining battery charge level or the remaining fuel level at the end of the remote air conditioning in addition to the battery charge amount or the fuel amount consumed by the execution of the remote air conditioning, and transmit the generated actual record information to the server 30. When the execution condition for the user-specified mode is not satisfied and the remote air conditioning is not executed, the in-vehicle terminal 100 may transmit information indicating that the execution condition is not satisfied to the server 30 instead of the actual record information.

The server 30 in the second modification transmits the actual record information to the user terminal 20 in response to reception of the actual record information transmitted from the in-vehicle terminal 100. Specifically, when the actual record information transmitted from the in-vehicle terminal 100 is received by the communication I/F 304 of the server 30, the processor 301 of the server 30 transmits the actual record information to the user terminal 20 via the communication I/F 304.

The user terminal 20 in the second modification presents the actual record information to the user of the vehicle 10 in response to reception of the actual record information transmitted from the server 30. Specifically, when the communication I/F 205 receives the actual record information transmitted from the server 30, the processor 201 of the user terminal 20 causes the input/output device 204 to output the actual record information.

### Software Configuration of User Terminal

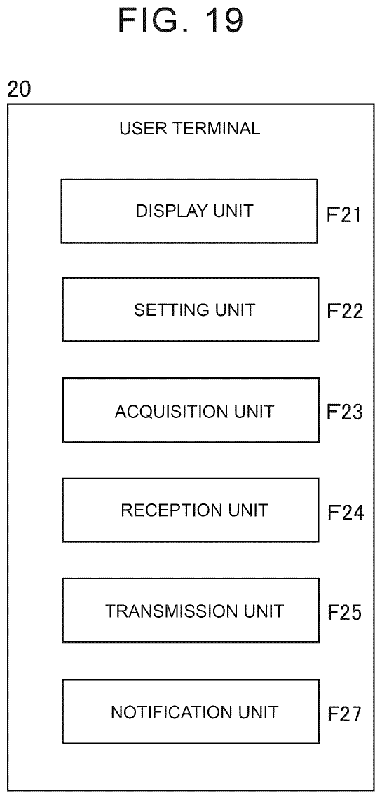

FIG. 19 is a block diagram schematically showing an example of the software configuration of the user terminal 20 according to the second modification. The user terminal 20 in the second modification operates as a computer including the display unit F21, the setting unit F22, the acquisition unit F23, the reception unit F24, the transmission unit F25, and a notification unit F27 as software modules by the processor 201 executing a program stored in the auxiliary storage device 203.

The display unit F21, the setting unit F22, the acquisition unit F23, the reception unit F24, and the transmission unit F25 in the second modification are similar to the display unit F21, the setting unit F22, the acquisition unit F23, the reception unit F24, and the transmission unit F25 in the above embodiment, and therefore their description will be omitted.

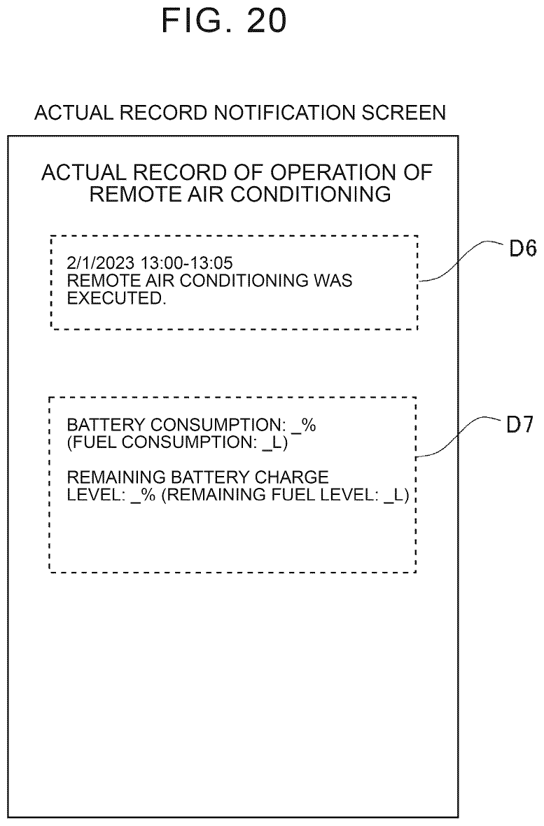

The notification unit F27 in the second modification causes the input/output device 204 to output an actual record notification screen in response to reception of the actual record information transmitted from the server 30. In one example, the actual record notification screen may include, as shown in FIG. 20, a display field D6 for a date and time of execution of the remote air conditioning, and a display field D7 for a battery charge amount (battery consumption) or a fuel amount (fuel consumption) consumed by the execution of the remote air conditioning. In addition to the battery consumption or the fuel consumption, the remaining battery charge level or the remaining fuel level at the end of the remote air conditioning may be displayed in the display field D7.

### Processing Flow

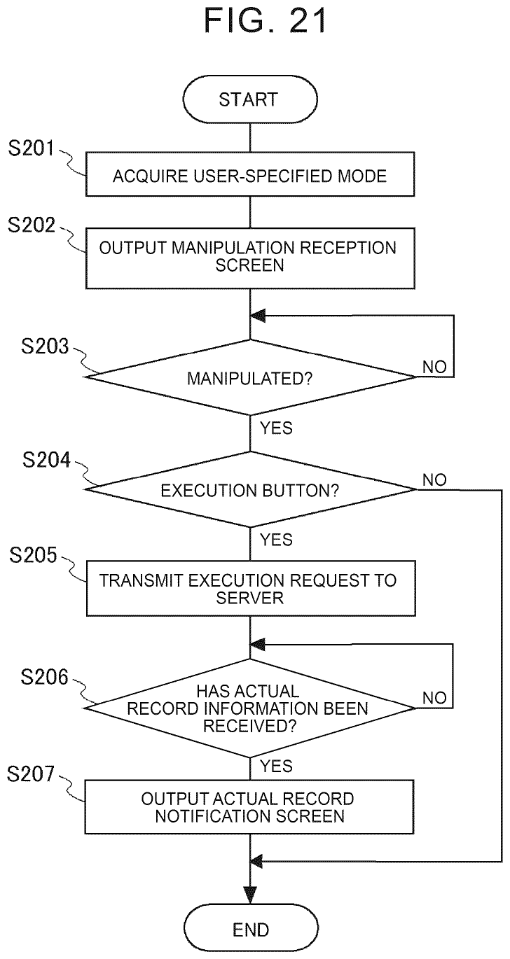

Next, a processing flow to be executed by the user terminal 20 in the second modification will be described with reference to FIG. 21. FIG. 21 is a flowchart showing a processing routine to be executed by the user terminal 20 when an operation for the remote air conditioning is received. In FIG. 21, processes similar to those in the processing routine in FIG. 13 are denoted by the same reference signs.

In the processing routine in FIG. 21, the processor 201 of the user terminal 20 operates as the notification unit F27 and executes a process of step S206 after the processes of steps S201 to S205 are executed. In step S206, the notification unit F27 determines whether the communication I/F 205 has received actual record information transmitted from the server 30. When the communication I/F 205 has not received the actual record information (negative determination in step S206), the notification unit F27 waits until the communication I/F 205 receives the actual record information. When the communication I/F 205 has received the actual record information (positive determination in step S206), the notification unit F27 executes a process of step S207.

In step S207, the notification unit F27 causes the input/output device 204 to output the actual record notification screen. As illustrated in FIG. 20, the actual record notification screen may include the display field D6 for the date and time of the execution of the remote air conditioning, and the display field D7 for the battery charge amount (battery consumption) or the fuel amount (fuel consumption) consumed by the execution of the remote air conditioning.

When the communication I/F 205 of the user terminal 20 receives information indicating that the execution condition for the user-specified mode is not satisfied instead of the actual record information, the notification unit F27 may terminate the execution of the processing routine in FIG. 21 without executing the process of step S207. Alternatively, the notification unit F27 may cause the input/output device 204 to output, instead of the actual record notification screen, a screen indicating that the execution condition for the user-specified mode is not satisfied and the remote air conditioning is not executed.

### Functions and Effects of Second Modification

In the second modification, after the remote air conditioning is executed in the user-specified mode, the user terminal 20 presents the battery charge amount or the fuel amount consumed by the execution of the remote air conditioning to the user of the vehicle 10. Thus, the user of the vehicle 10 can specify the user-specified mode and/or set the execution condition for the next remote air conditioning onwards using, as an index, the actual record value of the battery charge amount or the fuel amount consumed by the execution of the user-specified mode. As a result, the user of the vehicle 10 can specify the user-specified mode and/or set the execution condition more appropriately.

### Others

The embodiment and modifications described above are only examples, and the present disclosure may be modified as appropriate without departing from the gist of the present disclosure. For example, the execution condition for the user-specified mode need not be a variable condition set by the user, but may be a fixed condition preset for each vehicle 10. In this case, the vehicle 10 may determine whether the user-specified mode can be executed in accordance with the preset fixed execution condition. When determination is made that the execution condition for the user-specified mode is not satisfied, the user terminal 20 may prompt the user to select whether to execute the remote air conditioning in a mode other than the user-specified mode.

The processes and means described in the present disclosure may be combined as desired as long as no technical contradiction occurs. The process described as being executed by a single device may be executed by a plurality of devices in cooperation. Further, the process described as being executed by different devices may be executed by a single device. For example, at least part of the processes executed by the user terminal 20 may be executed by the server 30. In this case, the server 30 may acquire the user-specified mode, the execution condition, etc. by interacting with the user terminal 20 through the execution of a web server.

The present disclosure may be embodied such that a computer program that implements the functions described in the above embodiment is supplied to the user terminal 20 and is read and executed by the processor 201 of the user terminal 20. The computer program may be provided to the computer by being stored in a non-transitory computer-readable storage medium connectable to a system bus of the computer, or may be provided to the computer via a network. The non-transitory computer-readable storage medium is a recording medium that can store information such as data and programs by electrical, magnetic, optical, mechanical, or chemical action and can be read from a computer etc. Examples of the recording medium include any types of disk or disc such as magnetic disks (e.g., a floppy (registered trademark) disk and a hard disk drive (HDD)) and optical discs (e.g., a CD-ROM, a DVD, and a Blu-ray disc). Examples of the recording medium also include media such as a read only memory (ROM), a random access memory (RAM), an EPROM, an electrically erasable programmable read only memory (EEPROM), a magnetic card, a flash memory, an optical card, and a solid state drive (SSD).

What is claimed is:

1. An information processing device for remote control on a vehicle that executes a first mode in which an air conditioner is operated without operating an internal combustion engine, and a second mode in which the air conditioner is operated by operating the internal combustion engine, the information processing device comprising one or more processors, wherein
the one or more processors are configured to execute:
acquiring a user-specified mode that is the first mode or the second mode, and is specified by a user of the vehicle; and
transmitting an execution request for the user-specified mode to an external device related to the vehicle in response to acquiring of the user-specified mode.

2. The information processing device according to claim 1, wherein the one or more processors are configured to execute:
outputting a first screen for selecting whether to execute the acquired user-specified mode;
receiving a first operation that selects execution of the user-specified mode, in a case where the first screen is output; and
transmitting the execution request for the user-specified mode to the external device related to the vehicle in response to receiving the first operation.

3. The information processing device according to claim 2, further comprising a memory configured to store the user-specified mode, wherein
the one or more processors are configured to execute acquiring the user-specified mode stored in the memory.

4. The information processing device according to claim 3, wherein the one or more processors are configured to execute:
outputting a second screen for specifying the first mode or the second mode;
receiving a second operation that specifies the first mode or the second mode, in a case where the second screen is output; and
storing the first mode or the second mode specified by the received second operation in the memory as the user-specified mode.

5. The information processing device according to claim 4, wherein the one or more processors are configured to execute:
outputting a third screen for setting an execution condition for the user-specified mode;
receiving a third operation that sets the execution condition, in a case where the third screen is output; and
storing the execution condition set by the received third operation in the memory in association with the user-specified mode.

6. The information processing device according to claim 5, wherein the one or more processors are configured to execute:
when transmitting the execution request for the user-specified mode to the external device related to the vehicle,
acquire the execution condition stored in the memory; and
transmit the acquired execution condition to the external device together with the execution request for the user-specified mode.

7. The information processing device according to claim 6, wherein:
the execution condition in a case where the user-specified mode is the first mode is a condition related to a remaining charge level of a battery mounted on the vehicle; and
the execution condition in a case where the user-specified mode is the second mode is a condition related to a remaining fuel level in a fuel tank mounted on the vehicle.

8. The information processing device according to claim 1, wherein the one or more processors are configured to execute:
outputting a fourth screen for specifying the first mode or the second mode;
receiving a fourth operation that specifies the first mode or the second mode, in a case where the fourth screen is output; and
acquiring the first mode or the second mode specified by the received fourth operation as the user-specified mode.

9. The information processing device according to claim 8, wherein the one or more processors are configured to execute:
outputting a fifth screen for setting an execution condition for the user-specified mode;
receiving a fifth operation that sets the execution condition, in a case where the fifth screen is output; and
transmitting the execution condition set by the received fifth operation to the external device together with the execution request for the user-specified mode.

10. The information processing device according to claim 9, wherein:
the execution condition in a case where the user-specified mode is the first mode is a condition related to a remaining charge level of a battery mounted on the vehicle; and
the execution condition in a case where the user-specified mode is the second mode is a condition related to a remaining fuel level in a fuel tank mounted on the vehicle.

11. The information processing device according to claim 1, wherein:
the first mode is a mode in which the air conditioner is operated using electric power of a battery mounted on the vehicle;
the second mode is a mode in which the air conditioner is operated using electric power generated by using power of the internal combustion engine; and
the one or more processors are configured to execute:
acquiring, after the user-specified mode is executed in the vehicle, an actual record value of a battery charge amount or a fuel amount consumed by execution of the user-specified mode; and
outputting the acquired actual record value.

12. A non-transitory storage medium storing instructions that are executable by a computer for remote control on a vehicle and that cause the computer to perform functions, the vehicle being configured to execute a first mode in which an air conditioner is operated without operating an internal combustion engine, and a second mode in which the air conditioner is operated by operating the internal combustion engine, the functions comprising:
acquiring a user-specified mode that is the first mode or the second mode and is specified by a user of the vehicle; and
transmitting an execution request for the user-specified mode to an external device related to the vehicle in response to acquiring of the user-specified mode.

13. The storage medium according to claim 12, wherein the functions performed by the computer include:
outputting a first screen for selection as to whether to execute the acquired user-specified mode;
receiving a first operation to select execution of the user-specified mode, in a case where the first screen is output; and
transmitting the execution request for the user-specified mode to the external device related to the vehicle in response to receiving of the first operation.

14. The storage medium according to claim 13, wherein
the computer includes a memory configured to store the user-specified mode,
the functions performed by the computer include acquiring the user-specified mode stored in the memory.

15. The storage medium according to claim 14, wherein the functions performed by the computer include:
outputting a second screen for specifying the first mode or the second mode;
receiving a second operation to specify the first mode or the second mode while the second screen is output; and
storing the first mode or the second mode specified by the received second operation in the memory as the user-specified mode.

16. The storage medium according to claim 15, wherein the functions performed by the computer include:
outputting a third screen for setting an execution condition for the user-specified mode;
receiving a third operation to set the execution condition while the third screen is output; and
storing the execution condition set by the received third operation in the memory in association with the user-specified mode.

17. The storage medium according to claim 16, wherein the functions performed by the computer include:
when transmitting the execution request for the user-specified mode to the external device related to the vehicle,
acquiring the execution condition stored in the memory; and
transmitting the acquired execution condition to the external device together with the execution request for the user-specified mode.

18. The storage medium according to claim 17, wherein:
the execution condition in a case where the user-specified mode is the first mode is a condition related to a remaining charge level of a battery mounted on the vehicle; and
the execution condition in a case where the user-specified mode is the second mode is a condition related to a remaining fuel level in a fuel tank mounted on the vehicle.

19. The storage medium according to claim 12, wherein the functions performed by the computer include:
outputting a fourth screen for specifying the first mode or the second mode;
receiving a fourth operation to specify the first mode or the second mode while the fourth screen is output; and
acquiring the first mode or the second mode specified by the received fourth operation as the user-specified mode.

20. The storage medium according to claim 19, wherein the functions performed by the computer include:
outputting a fifth screen for setting an execution condition for the user-specified mode;
receiving a fifth operation to set the execution condition, in a case where the fifth screen is output; and
transmitting the execution condition set by the received fifth operation to the external device together with the execution request for the user-specified mode.
